(19) United States
(12) Patent Application Publication
(10) Pub. No.: US 2011/0081567 A1
(43) Pub. Date: Apr. 7, 2011

(54) BATTERY MODULE ASSEMBLY OF STARTING POWER UNIT FOR POWER GENERATOR

(75) Inventors: Wen-Hua Lin, Yilan County (TW); Yun-Yuan Chu, Taipei (TW)

(73) Assignees: NATIONAL ENERGY TECHNOLOGY CO., LTD., Tucheng City (TW); APOGEE POWER, INC., Campbell, CA (US); ORCHARD ELECTRONICS COMPANY LTD., Xindian City (TW)

(21) Appl. No.: 12/692,648

(22) Filed: Jan. 24, 2010

(30) Foreign Application Priority Data
Oct. 1, 2009 (TW) 098133465

(51) Int. Cl. H01M 2/10

(52) U.S. Cl. 429/99

(57) ABSTRACT

A battery module assembly is composed of a main body, a plurality of battery modules, and at least one fastening member. The main body includes a plurality of compartments, each of which can communicate with the outside thereof and which are vertically arranged along at least one stack. The battery modules are removably mounted to the compartments respectively. Each of the at least one fastening member is made of electrically conductive material and mounted to the battery module according to the arrangement of the compartments to enable each of the battery modules to be mechanically and electrically connected with the fastening member. Therefore, the battery module assembly enables the battery modules to be conveniently replaced and maintained.

### BACKGROUND OF THE INVENTION

1. Field of the Invention

The present invention relates generally to starting power units for power generators, and more particularly to a battery module assembly of a starting power unit for a power generator.

2. Description of the Related Art

After the electric energy already stored in a starting power unit for a general power generator activates a starting motor, the starting motor drives the power generator to generate and supply electricity for the clients in need.

The starting power unit for the power generator usually includes at least one lead-acid battery mounted inside a starter and connected with the starting motor via a cable and a switch to provide the starting motor with required electricity. When the lead-acid battery needs to be replaced, it is necessary to detach the starter from the starting motor and then separate the battery from the starter.

However, it is troublesome and inconvenient to replace the battery mounted inside the starting power unit for the power generator. Besides, before the replacement, it is also necessary to cut off the electric connection between the starter and the starting motor and then to repair the starter. Therefore, the maintenance of the power generator is complicated.

### SUMMARY OF THE INVENTION

The primary objective of the present invention is to provide a battery module assembly, which enables the battery modules therein to be conveniently replaced and maintained.

The foregoing objective of the present invention is attained by the battery module assembly composed of a main body, a plurality of battery modules, and at least one fastening member. The main body includes a plurality of compartments, each of which can communicate with the outside thereof and which are vertically arranged along at least one stack. The battery modules are removably mounted to the compartments respectively. Each of the at least one fastening member is made of electrically conductive material and mounted to the battery modules according to the arrangement of the compartments to enable each of the battery modules to be mechanically and electrically connected with the fastening member.

### BRIEF DESCRIPTION OF THE DRAWINGS

FIG. 1 is a front view of a preferred embodiment of the present invention.

FIG. 2 is a rear view of the preferred embodiment of the present invention.

FIG. 3 is a top view of the preferred embodiment of the present invention.

FIG. 4 is a side view of the preferred embodiment of the present invention.

FIG. 5 is an exploded view of the preferred embodiment of the present invention.

FIG. 6 is a sectional view taken from a line 6-6 indicated in FIG. 3.

FIG. 7 is a sectional view taken from a line 7-7 indicated in FIG. 4.

FIG. 8 is a sectional view taken from a line 8-8 indicated in FIG. 4.

### DETAILED DESCRIPTION OF PREFERRED EMBODIMENTS

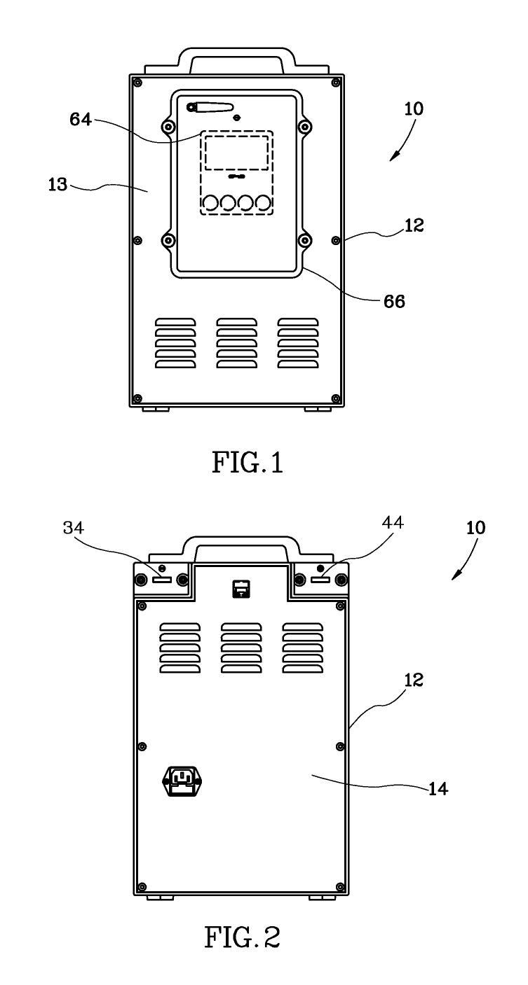

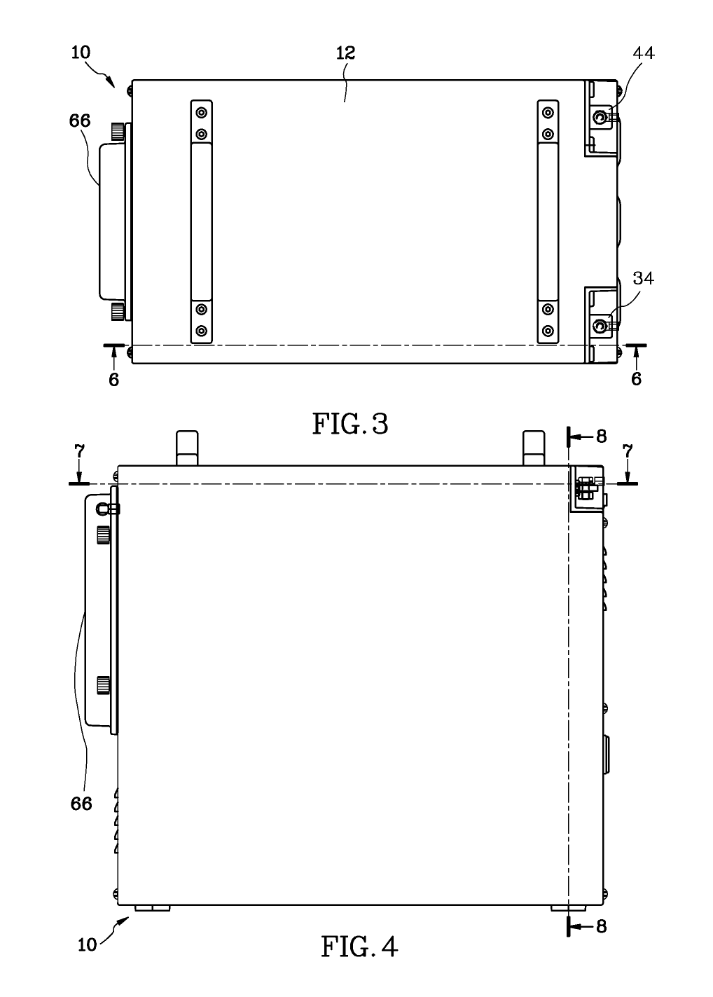

Referring to FIGS. 1-5, a battery module assembly of a starting power unit for a power generator is composed of a main body 10, a plurality of battery modules 20, a first fastening member 30, and a second fastening member 40.

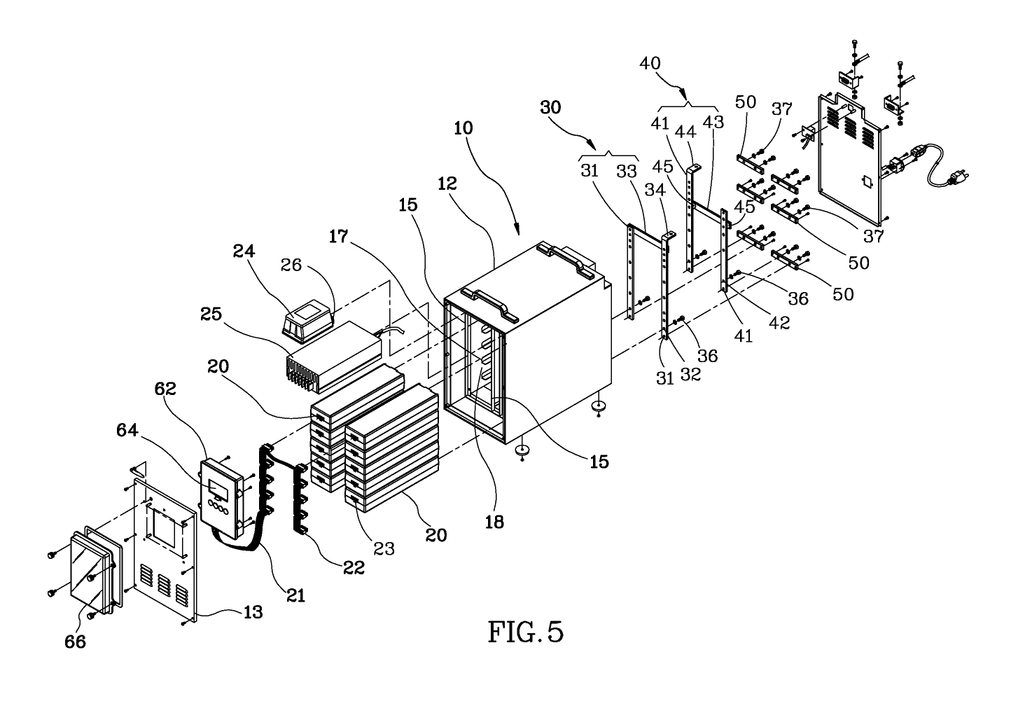

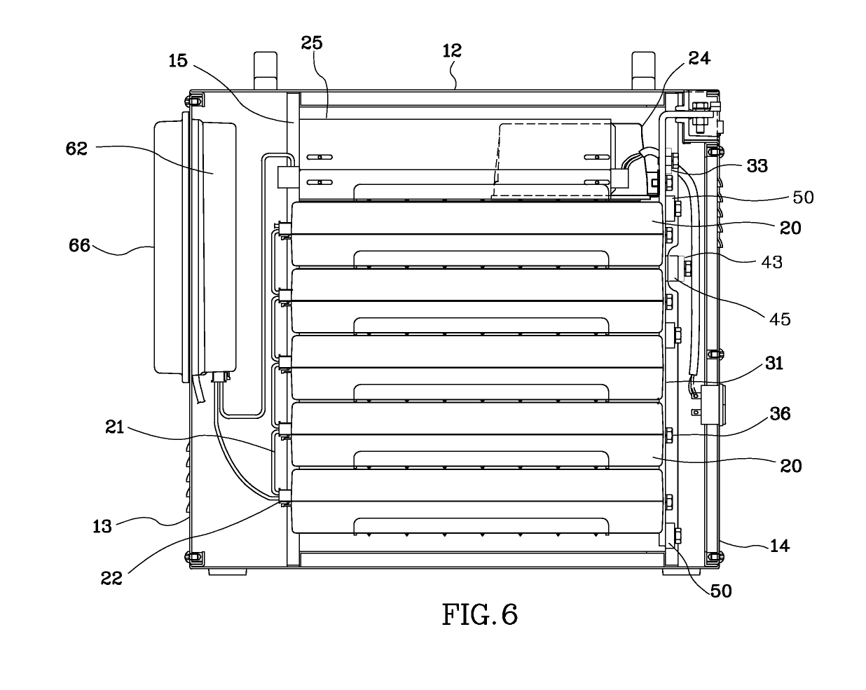

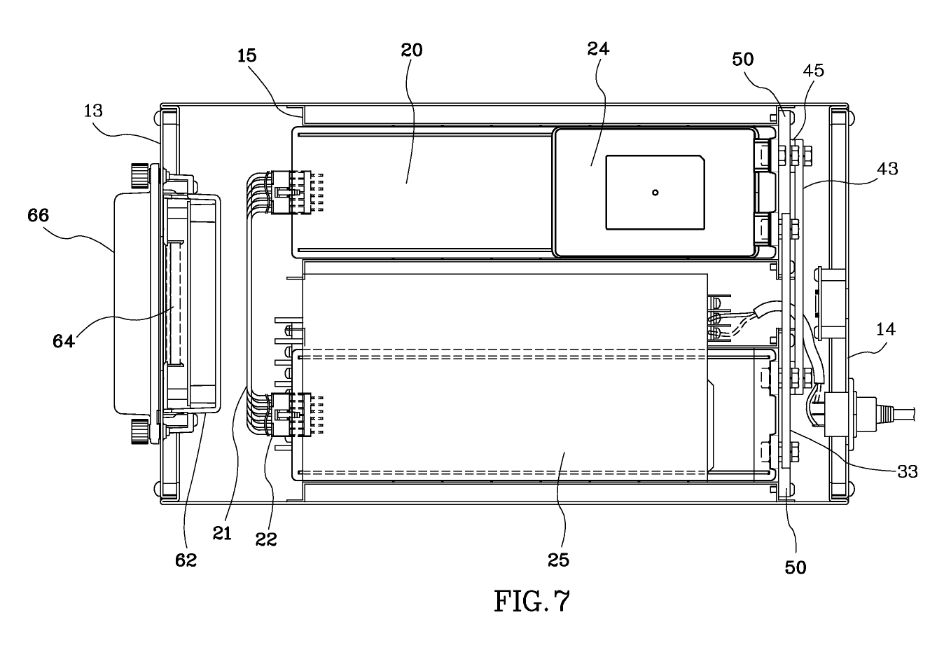

The main body 10 includes a tower-shaped housing 12, a front panel 13 mounted to a front end of the housing 12, and a rear panel 14 mounted to a rear end face of the housing 12. As shown in FIGS. 5 and 7-8, the housing 12 has two pairs of upright partitions 15 mounted therein, a plurality of guide rails 17 each mounted between two opposite internal sidewalls of one of the two pairs of the partitions 15 and extending in parallel, and a number of compartments 18 formed between the partitions 15 and the guide rails 17. The compartments 18 are arranged in two rows side by side along an upright axial direction.

The control module 62 is mounted to an internal side of the front panel 13 and electrically connected with the battery modules 20 via a cable 21. The control module 62 includes a display device 64 for showing the operational status of the battery modules 20 through the front panel 13. The front panel 13 has a protective cover 66 corresponding to the display device 64. An electric energy storage device 24 and a power supply 25 are mounted to the two compartments located at an internal topmost side of the main body 10 respectively. The electric energy storage device 24 is a supercapacitor in this embodiment. The power supply 25 can charge the battery modules 20 after connection with an external power source.

Each of the battery modules 20 is a lithium-ion battery pack and inserted into one of the compartments 18 through a rear side of the housing 12 in such a way that the battery modules 20 can be inserted into or retrieved from the compartments 18 along the guide rails 17 of the main body 10. When the battery modules 20 are inserted into the compartments 18 respectively, the battery modules 20 are connected with a bus connector 22 of the cable 21.

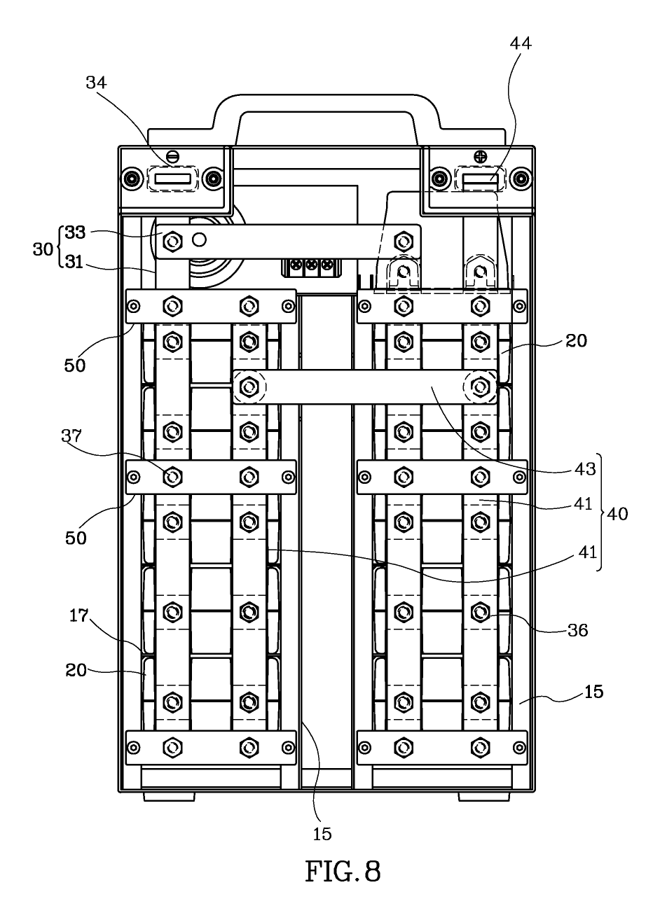

Referring to FIGS. 5 and 8, each of the first and second fastening members 30 and 40 is made of an electrically conductive material. The first fastening member 30 includes two elongated connection parts 31 and an extension parts 33 connected with the two connection parts 31. The second fastening member 40 also includes two elongated connection parts 41 and an extension parts 43 connected with the two connection parts 41. The extension parts 33 are mounted to top ends of the two connection parts 31 respectively. The extension parts 43 are mounted to positions close to midsections of the two connection parts 41 respectively. Two washers 45 are mounted respectively between one of two ends of the extension part 43 and one of the two connection parts 41 and between the other end of the extension part 43 and the other connection part 41. Each of the first and second connection parts 31 and 41 has a plurality of through holes 32 (42). One of the connection parts 31(41) is provided with a bent portion 34(44) formed at one end thereof. The two bent portions 33 and 44 are served as a positive electrode and a negative electrode of an output power source of the present invention.

The first and second fastening members 30 40 are fixedly mounted to the battery module 20 by a plurality of threaded fasteners 36 inserted into the through holes 32 and 42. In this way, the connection parts 31 and 41 and the extension parts 33 and 43 of the fastening members 30 and 40 are electrically connected with the electrodes of the same polarity of the battery modules 20, and then are electrically connected with the two electrodes 26 of the electric energy storage device 24 to enable parallel connection between the battery modules 20 and the electric energy storage device 24 in such a way that the first and second fastening members 30 and 40 can enable the battery modules 20 and the electric energy storage device 24 to be mechanically and electrically connected with the main body 10 firmly. The extension part 43 of the second fastening member 40 can avoid contact with the first fastening member 30 by the washer 45. A plurality of insulative connection pieces 50 are transversally mounted among the first and second fastening members 30 and 40 and the partitions 15 and fixed to the connection parts 31 and 41 and the partitions 15 via screws 37 to reinforce the strength of combination between the first and second fastening members 30 and 40 and the main body 10.

Referring to FIG. 8, the battery modules 20 are stacked in two rows inside the main body 10. The connection parts 31 and 41 of the first and second fastening members 30 and 40 are alternately arranged to fasten the battery modules 20, thus not only enabling the battery modules 20 and the electric energy storage device 24 to output electric energy in parallel connection but enabling relatively more compact arrangement of the elements of the present invention for decreasing the whole size.

In light of the above structure, each of the battery modules 20 can be inserted into or retrieved from one of the compartments 18 along the guide rails 17. After the battery modules 20 are inserted into the compartments 18, the bus connector 22 is fixed to an output connector 23 of each battery module 20 and the fastening members 30 and 40 are fixed to the main body 10, such that the battery modules 20 can be firmly mounted inside the main body 10. Besides, the battery modules 20 and the electric energy storage device 24 are connected in parallel via the fastening members 30 and 40 for outputting the electric energy already stored therein via the positive and negative electrodes. When one of the battery modules 20 is damaged, it can be replaced by detaching the fastening members 30 straight from the damaged battery module 20, then removing the first and second fastening members 30 and 40 and the damaged battery module 20 from the compartment 18, and finally inserting a new one into the compartment 18 to complete the replacement.

In conclusion, the present invention can firmly hold the battery modules to enable the battery modules to be conveniently maintained and replaced.

Although the present invention has been described with respect to a specific preferred embodiment thereof, it is in no way limited to the specifics of the illustrated structures but changes and modifications may be made within the scope of the appended claims.

What is claimed is:

1. A battery module assembly of a starting power unit for a power generator, comprising:
a main body having a plurality of compartments, each of which communicates with an outside of the main body, the compartments being vertically arranged in the main body along at least one stack;
a plurality of battery modules removably mounted to the plurality of compartments respectively; and
at least one fastening member made of electrically conductive material, each of which is mounted to the battery modules according to the arrangement of the compartments in such a way that the battery modules are mechanically and electrically connected with the fastening members.

2. The battery module assembly as defined in claim 1, wherein the main body comprises a plurality of partitions mounted therein, a plurality of guide rails mounted between the partitions, and the compartments are formed between the guide rails.

3. The battery module assembly as defined in claim 1, wherein each of the fastening members comprises a plurality of through holes and is fixed to the battery modules by a plurality of threaded fasteners inserted into the through holes respectively in such a way that the fastening members are mounted to the battery modules according to the arrangement of the compartments.

4. The battery module assembly as defined in claim 2, further comprising at least one connection piece connecting the at least one fastening member and the partitions.

5. The battery module assembly as defined in claim 1, wherein one of the at least one fastening member comprises two connection parts and an extension part connected with the connection parts, each of the connection parts having a plurality of through holes, one of the connection parts having a bended portion at one end thereof.

6. The battery module assembly as defined in claim 5 further comprising a plurality of washers, wherein the washers are mounted between the connection parts and the extension part.

7. The battery module assembly as defined in claim 1, wherein each of the at least one fastening member is electrically connected with electrodes of the same polarity of the battery modules and then connected with an electric energy storage device in parallel.
